(19) United States
(12) Patent Application Publication
(10) Pub. No.: US 2024/0147999 A1
(43) Pub. Date: May 9, 2024

(54) PESTICIDAL FORMULATIONS

(71) Applicant: SYNGENTA CROP PROTECTION AG, Basel (CH)

(72) Inventors: Elizabeth Gray WILLIARD, Greensboro, NC (US); Manoj VARSHNEY, Greensboro, NC (US); Colin Douglas MILN, Greensboro, NC (US)

(73) Assignee: SYNGENTA CROP PROTECTION AG, Basel (CH)

(21) Appl. No.: 18/547,550

(22) PCT Filed: Feb. 23, 2022
(86) PCT No.: PCT/EP2022/054531

§ 371 Date: Aug. 23, 2023

(30) Foreign Application Priority Data
Mar. 1, 2021 (EP) 21160052.3

(51) Int. Cl. A01N 43/88; A01N 25/30; A01P 5/00; A01P 7/02; A01P 7/04; A01P 9/00

(52) U.S. Cl. CPC A01N 43/88; A01N 25/30; A01P 5/00; A01P 7/02; A01P 7/04; A01P 9/00

(57) ABSTRACT

The present invention relates to pesticidally-active, in particular insecticidally-active, compositions comprising Thiamethoxam, and to their use for controlling animal pests in field crops.

The present invention relates to pesticidally-active, in particular insecticidally-active, compositions comprising Thiamethoxam, and to their use for controlling animal pests in field crops. Pesticidal formulations comprising Thiamethoxam are known, for example, from WO 01/20986. However, there is a continuing need to provide pesticidal compositions which possess any number of benefits including, inter alia, advantageous levels of biological activity for protecting plants against insects or superior properties for use as agrochemical active ingredients (for example, greater biological activity, an advantageous spectrum of activity, an increased safety profile (including improved crop tolerance), improved physico-chemical properties, or increased biodegradability). It has now been found that further formulations comprising Thiamethoxam and specific combinations of surfactants provide superior stability performances in aqueous compositions of Thiamethoxam, especially in formulations including flowable concentrates for seed treatment of Thiamethoxam. According to a first aspect of the present invention, there is provided a pesticidal composition comprising:
(a) a compound of formula (I):

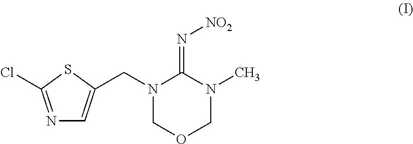 [SMILES: CN1COCN(Cc2cnc(Cl)s2)/C1=N/[N+](=O)[O-]]

or an agrochemically acceptable salt, stereoisomer, enantiomer, tautomer or N-oxide thereof;
(b) water; and
(c) a surfactant system comprising:

at least one block copolymer of ethylene oxide and propylene oxide of formula (II):

HO—(CH₂CH₂O)ₓ—(CH(CH₃)CH₂O)_{y}—(CH₂CH₂O)ₓ—H (II)

wherein

x and x′, equal to or different from each other, are integers from 70 to 120, and

y is an integer from 20 to 45, and

wherein the polyoxyethylene:polyoxypropylene chain length ratio is from 4:1 to 7:1, and at least one alkoxylated lignosulfonate salt of formula (III):

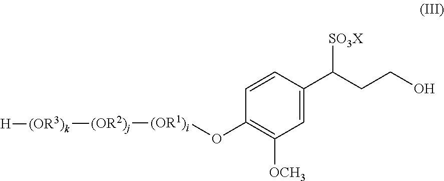

wherein

R¹, R² and R³, equal to or different from each other, are independently selected from —CH₂CH₂—, —CH(CH₃)CH₂— and —CH₂CH₂CH₂CH₂—,

i, j and k, equal to or different from each other, are 0 or integers from 1 to 15, with the proviso that at least one of i, j and k is different from 0, and

X is sodium or potassium.

For the purpose of the present invention, the pesticidal composition according to the invention is intended to cover all bioequivalent compositions thereof.

Surprisingly, it has been found that the novel pesticidal compositions of the present invention show a long term physical stability upon storage in combination with good crystral growth inhibition properties as well as a very advantageous level of biological activity for controlling or preventing damage to plants caused by insects. The pesticidal compositions of the present invention also unexpectedly show good stability upon dilution at the application rates.

Typically, the pesticidal composition of the invention comprises:
(a) a compound of formula (I):

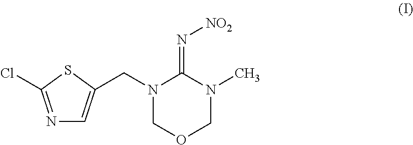 [SMILES: CN1COCN(Cc2cnc(Cl)s2)/C1=N/[N+](=O)[O-]]

or an agrochemically acceptable salt, stereoisomer, enantiomer, tautomer or N-oxide thereof;
(b) water;
(c) a surfactant system comprising:

at least one block copolymer of ethylene oxide and propylene oxide of formula (II):

HO—(CH₂CH₂O)ₓ—(CH(CH₃)CH₂O)_{y}—(CH₂CH₂O)ₓ—H

wherein

x and x′, equal to or different from each other, are integers from 70 to 120, and

y is an integer from 20 to 45, and

wherein the polyoxyethylene:polyoxypropylene chain length ratio is from 4:1 to 7:1, and at least one alkoxylated lignosulfonate salt of formula (111):

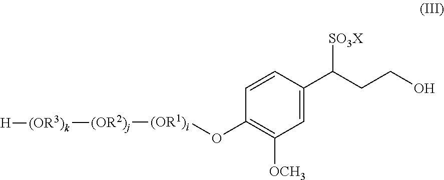

wherein

R¹, R² and R³, equal to or different from each other, are independently selected from —CH₂CH₂—, —CH(CH₃)CH₂— and —CH₂CH₂CH₂CH₂—,

i, j and k, equal to or different from each other, are 0 or integers from 1 to 15, with the proviso that at least one of i, j and k is different from 0, and

X is sodium or potassium;
(d) at least one clay; and
(e) at least one heteropolysaccharide.

Typically, water in the pesticidal composition of the invention is the complement to 100% by weight, with respect to the total weight of the composition.

Surprisingly, it has been also found that the use of at least one clay in combination with at least one heteropolysaccharide in the pesticidal compositions of the present invention unexpectedly further helps in preventing the formation of a sediment and, when a sediment is formed, allows for its easier rehomogenisation.

Preferably, the pesticidal composition of the invention comprises:
(a) from 10% to 75% by weight, with respect to the total weight of the composition, of the compound of formula (I), or an agrochemically acceptable salt, stereoisomer, enantiomer, tautomer or N-oxide thereof;
(b) from 10% to 65% by weight, with respect to the total weight of the composition, of water;
(c) from 1% to 25% by weight, with respect to the total weight of the composition, of the surfactant system;
(d) from 0.1% to 2% by weight, with respect to the total weight of the composition, of at least one clay; and
(e) from 0.05% to 1% by weight, with respect to the total weight of the composition, of at least one heteropolysaccharide.

More preferably, the pesticidal composition of the invention comprises:
(a) from 25% to 60% by weight, with respect to the total weight of the composition, of the compound of formula (I) or an agrochemically acceptable salt, stereoisomer, enantiomer, tautomer or N-oxide thereof;
(b) from 25% to 60% by weight, with respect to the total weight of the composition, of water;
(c) from 2% to 15% by weight, with respect to the total weight of the composition, of the surfactant system;
(d) from 0.5% to 1.5% by weight, with respect to the total weight of the composition, of at least one clay; and
(e) from 0.05% to 0.15% by weight, with respect to the total weight of the composition, of at least one heteropolysaccharide.

Even more preferably, the pesticidal composition of the invention comprises:
(a) from 40% to 60% by weight, with respect to the total weight of the composition, of the compound of formula (I) or an agrochemically acceptable salt, stereoisomer, enantiomer, tautomer or N-oxide thereof;
(b) from 30% to 50% by weight, with respect to the total weight of the composition, of water;
(c) from 4% to 10% by weight, with respect to the total weight of the composition, of the surfactant system;
(d) from 0.08% to 1.2% by weight, with respect to the total weight of the composition, of at least one clay; and
(e) from 0.06% to 0.15% by weight, with respect to the total weight of the composition, of at least one heteropolysaccharide.

The term “chain length ratio” as used herein means the ratio between the total number of the oxyethylene units, namely —(CH₂CH₂O)ₓ— and —(CH₂CH₂O)ₓ′—, and the total number of the oxypropylene units, namely —(CH(CH₃)CH₂O)_{y}—, wherein x, x′ and y are defined as above.

The term “polyoxyethylene” as used herein means one or more polymer chains containing oxyethylene units.

The term “polyoxypropylene” as used herein means one or more polymer chains containing oxypropylene units.

Preferably, in the block copolymer of ethylene oxide and propylene oxide of formula (II)

x and x′, equal to or different from each other, are integers from 70 to 120, and

y is an integer from 20 to 45,

wherein the polyoxyethylene:polyoxypropylene chain length ratio is from 4:1 to 6:1, preferably from 5:1 to 6:1.

In an embodiment of the invention, in the block copolymer of ethylene oxide and propylene oxide of formula (II)

x and x′, equal to each other, are integers from 70 to 120, and

y is an integer from 20 to 45,

wherein the polyoxyethylene:polyoxypropylene chain length ratio is from 4:1 to 6:1, preferably from 5:1 to 6:1.

Preferred examples of block copolymers of ethylene oxide and propylene oxide of formula (II) according to this embodiment of the invention are selected from the group consisting of:
HO—(CH₂CH₂O)₈₀—(CH(CH₃)CH₂O)₃₀—(CH₂CH₂O)₈₀—H;
HO—(CH₂CH₂O)₉₇—(CH(CH₃)CH₂O)₃₉—(CH₂CH₂O)₉₇—H; and
HO—(CH₂CH₂O)₁₁₈—(CH(CH₃)CH₂O)₄₅—(CH₂CH₂O)₁₁₈—H.

More preferably, in the block copolymer of ethylene oxide and propylene oxide of formula (II)

x and x′, equal to or different from each other, are integers from 70 to 120, and

y is an integer from 20 to 35,

wherein the polyoxyethylene:polyoxypropylene chain length ratio is from 4:1 to 6:1, preferably from 5:1 to 6:1.

Even more preferably, in the block copolymer of ethylene oxide and propylene oxide of formula (II)

x and x′, equal to or different from each other, are integers from 75 to 85, and

y is an integer from 25 to 35,

wherein the polyoxyethylene:polyoxypropylene chain length ratio is from 5:1 to 6:1.

Still more preferably, in the block copolymer of ethylene oxide and propylene oxide of formula (II)

x and x′, equal to or different from each other, are integers from 75 to 80, and

y is an integer from 25 to 30,

wherein the polyoxyethylene:polyoxypropylene chain length ratio is from 5:1 to 6:1, preferably from 5.1:1 to 5.5:1.

Non-limiting examples of block copolymers of ethylene oxide and propylene oxide of formula (II) suitable for use in the pesticidal composition of the invention include, for instance, surfactants which are commercially available under the trademark names PLURONIC® F68, PLURONIC® F88 and PLURONIC® F98.

Preferably, in the alkoxylated lignosulfonate salt of formula (III)

when any of R¹, R² and R³ is —CH₂CH₂, i, j and k, equal to or different from each other, are integers from 1 to 12, preferably from 1 to 4, more preferably from 1 to 3, or

when any of R¹, R² and R³ is —CH(CH₃)CH₂, i, j and k, equal to or different from each other, are integers from 1 to 6, preferably from 1 to 3, more preferably from 1 to 2, or

when any of R¹, R² and R³ is —CH₂CH₂CH₂CH₂—, i, j and k, equal to or different from each other, are integers from 1 to 3, preferably from 1 to 2, more preferably 1,

wherein R¹, R² and R³ are equal to or different from each other.

Preferably, X in the alkoxylated lignosulfonate salt of formula (III) is sodium.

Preferably, the alkoxylated lignosulfonate salt of formula (III) has a degree of sulfonation from 0.5 to 1.5 moles/Kg, preferably from 0.7 to 1.2 moles/Kg.

Non-limiting examples of alkoxylated lignosulfonate salts of formula (III) suitable for use in the pesticidal composition of the invention include, for instance, a surfactant which is commercially available under the trademark name REAX® 1425E.

Preferably, the surfactant system comprises:

from 20% to 45% by weight, with respect to the total weight of the surfactant system, of at least one polyoxyethylene-polyoxypropylene block copolymer of formula (II); and

from 55% to 80% by weight, with respect to the total weight of the surfactant system, of at least one alkoxylated lignosulfonate salt of formula (III).

More preferably, the surfactant system comprises:

from 30% to 40% by weight, with respect to the total weight of the surfactant system, of at least one polyoxyethylene-polyoxypropylene block copolymer of formula (II); and

from 60% to 70% by weight, with respect to the total weight of the surfactant system, of at least one alkoxylated lignosulfonate salt of formula (III).

Even more preferably, the surfactant system comprises:

from 35% to 40% by weight, with respect to the total weight of the surfactant system, of at least one polyoxyethylene-polyoxypropylene block copolymer of formula (II); and from 60% to 65% by weight, with respect to the total weight of the surfactant system, of at least one alkoxylated lignosulfonate salt of formula (III).

Preferably, the clay is selected from smectite clay minerals such as hydrous aluminum silicate minerals comprising any of montmorillonite, saponite, beidellite, nontronite, hectorite and stevensite.

More preferably, the clay is a dioctahedral smectite of formula (Na,Ca)_{0.33}(Al_{1.67}Mg_{0.33})Si₄O₁₀(OH)₂·nH₂O.

Non-limiting examples of clays suitable for use in the pesticidal composition of the invention include, for instance, a smectite clay mineral which is commercially available under the trademark name VOLCLAY® 325.

Preferably, the heteropolysaccharide is selected from the group consisting of pectin, tamarind seed gum, guar gum, locust bean (carob seed) gum, konjac gum, xanthan gum, alginates and agar.

More preferably, the heteropolysaccharide is xanthan gum.

Preferably, the weight ratio of at least one clay to at least one heteropolysaccharide in the pesticidal composition of the invention is from 8:1 to 15:1, preferably from 9:1 to 13:1, more preferably from 9:1 to 12:1, even more preferably from 9:1 to 10:1.

Preferred pesticidal compositions according to the invention are flowable concentrates for seed treatment comprising:
(a) from 40% to 60% by weight, with respect to the total weight of the composition, of the compound of formula (I) or an agrochemically acceptable salt, stereoisomer, enantiomer, tautomer or N-oxide thereof;
(b) from 30% to 50% by weight, with respect to the total weight of the composition, of water;
(c) from 4% to 10% by weight, with respect to the total weight of the composition, of a surfactant system comprising:
   from 35% to 40% by weight, with respect to the total weight of the surfactant system, of at least one polyoxyethylene-polyoxypropylene block copolymer of formula (II):

HO—(CH₂CH₂O)ₓ—(CH(CH₃)CH₂O)_{y}—(CH₂CH₂O)ₓ—H

wherein

x and x′, equal to or different from each other, are integers from 75 to 80, and

y is an integer from 25 to 30, and

wherein the polyoxyethylene:polyoxypropylene chain length ratio is from 5:1 to 6:1, more preferably from 5.1:1 to 5.5:1; and

from 60% to 65% by weight, with respect to the total weight of the surfactant system, of at least one alkoxylated lignosulfonate salt of formula (III):

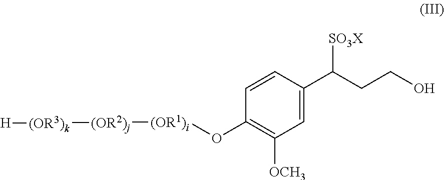

wherein

R¹, R² and R³, equal to or different from each other, are independently selected from —CH₂CH₂—, —CH(CH₃)CH₂— and —CH₂CH₂CH₂CH₂—,

i, j and k, equal to or different from each other, are 0 or integers from 1 to 15, with the proviso that at least one of i, j and k is different from 0, and

X is sodium;
(d) from 0.08% to 1.2% by weight, with respect to the total weight of the composition, of at least one clay; and
(e) from 0.06% to 0.15% by weight, with respect to the total weight of the composition, of at least one heteropolysaccharide;

wherein the weight ratio of at least one clay to at least one heteropolysaccharide in the composition of the invention is from 8:1 to 15:1, preferably from 9:1 to 13:1, more preferably from 9:1 to 12:1, even more preferably from 9:1 to 10:1.

According to a second aspect of the invention, there is provided a method of controlling insects, acarines, nematodes or molluscs which comprises applying the pesticidal composition according to the invention to a pest, a locus of pest (preferably a plant), to a plant susceptible to attack by a pest or to plant a propagation material thereof (such as a seed). According to this particular aspect of the invention, the method may exclude methods for the treatment of the human or animal body by surgery or therapy.

According to a third aspect of the invention, there is provided the use of the pesticidal composition according to the invention as an insecticide, acaracide, nematicide or molluscicide. According to this particular aspect of the invention, the use may exclude methods for the treatment of the human or animal body by surgery or therapy.

The term “controlling” when used in context of parasites in or on an animal refers to reducing the number of pests or parasites, eliminating pests or parasites and/or preventing further pest or parasite infestation.

The presence of one or more possible asymmetric carbon atoms in a compound of formula (I) means that the compounds may occur in chiral isomeric forms, i.e., enantiomeric or diastereomeric forms.

Also, atropisomers may occur as a result of restricted rotation about a single bond. Formula (I) is intended to include all those possible isomeric forms and mixtures thereof. The present invention includes all those possible isomeric forms and mixtures thereof for a compound of formula (I).

Likewise, formula (I) is intended to include all possible tautomers where present. The present invention includes all possible tautomeric forms for a compound of formula (I).

In each case, the compound of formula (I) is in free form, in oxidized form as an N-oxide, in covalently hydrated form, or in salt form, e.g., an agronomically usable or agrochemically acceptable salt form. N-oxides are oxidized forms of tertiary amines or oxidized forms of nitrogen containing heteroaromatic compounds. They are described for instance in the book “Heterocyclic N-oxides” by A. albini and S. pietra, CRC Press, Boca Raton 1991. The compound of formula (I) according to the invention also include hydrates, which may be formed during salt formation.

The compound of formula (I) is either commercially available, prepared by known procedures or otherwise obtained using known chemistry.

The compound of formula (I) according to the invention can be prepared via the methods described in, for example, WO 01/00623, WO 02/34734 and US 2003/0232821.

Salts of compound of formula (I) can be prepared in a manner known per se. Thus, for example, acid addition salts of compound of formula (I) are obtained by treatment with a suitable acid or a suitable ion exchanger reagent and salts with bases are obtained by treatment with a suitable base or with a suitable ion exchanger reagent.

Salts of compound of formula (I) can be converted in the customary manner into the free compounds (I), acid addition salts, for example, by treatment with a suitable basic compound or with a suitable ion exchanger reagent and salts with bases, for example, by treatment with a suitable acid or with a suitable ion exchanger reagent.

Salts of compounds of formula (I) can be converted in a manner known per se into other salts of compound of formula (I), acid addition salts, for example, into other acid addition salts, for example by treatment of a salt of inorganic acid such as hydrochloride with a suitable metal salt such as a sodium, barium or silver salt, of an acid, for example with silver acetate, in a suitable solvent in which an inorganic salt which forms, for example silver chloride, is insoluble and thus precipitates from the reaction mixture.

Depending on the procedure or the reaction conditions, the compound of formula (I), which have salt-forming properties, can be obtained in free form or in the form of salts.

The compound of formula (I) and, where appropriate, the tautomer's thereof, in each case in free form or in salt form, can be present in the form of one of the isomers which are possible or as a mixture of these, for example in the form of pure isomers, such as antipodes and/or diastereomers, or as isomer mixtures, such as enantiomer mixtures, for example racemates, diastereomer mixtures or racemate mixtures, depending on the number, absolute and relative configuration of asymmetric carbon atoms which occur in the molecule and/or depending on the configuration of non-aromatic double bonds which occur in the molecule, the invention relates to the pure isomers and also to all isomer mixtures which are possible and is to be understood in each case in this sense hereinabove and herein below, even when stereochemical details are not mentioned specifically in each case.

Diastereomeric mixtures or racemic mixtures of compound of formula (I), in free form or in salt form, which can be obtained depending on which starting materials and procedures have been chosen can be separated in a known manner into the pure diastereomers or racemates on the basis of the physicochemical differences of the components, for example by fractional crystallization, distillation and/or chromatography.

Enantiomeric mixtures, such as racemates, which can be obtained in a similar manner can be resolved into the optical antipodes by known methods, for example by recrystallization from an optically active solvent, by chromatography on chiral adsorbents, for example high-performance liquid chromatography (HPLC) on acetyl cellulose, with the aid of suitable microorganisms, by cleavage with specific, immobilized enzymes, via the formation of inclusion compounds, for example using chiral crown ethers, where only one enantiomer is complexed, or by conversion into diastereomeric salts, for example by reacting a basic end-product racemate with an optically active acid, such as a carboxylic acid, for example camphor, tartaric or malic acid, or sulfonic acid, for example camphorsulfonic acid, and separating the diastereomer mixture which can be obtained in this manner, for example by fractional crystallization based on their differing solubilities, to give the diastereomers, from which the desired enantiomer can be set free by the action of suitable agents, for example basic agents. Pure diastereomers or enantiomers can be obtained according to the invention not only by separating suitable isomer mixtures, but also by generally known methods of diastereoselective or enantioselective synthesis, for example by carrying out the process according to the invention with starting materials of a suitable stereochemistry.

It is advantageous to isolate or synthesize in each case the biologically more effective isomer, for example enantiomer or diastereomer, or isomer mixture, for example enantiomer mixture or diastereomer mixture, if the individual components have a different biological activity.

The compound of formula (I) and, where appropriate, the tautomers thereof, in each case in free form or in salt form, can, if appropriate, also be obtained in the form of hydrates and/or include other solvents, for example those which may have been used for the crystallization of compounds which are present in solid form.

The block copolymers of ethylene oxide and propylene oxide of formula (II) are either commercially available, prepared by known procedures or otherwise obtained using known chemistry.

The alkoxylated lignosulfonate salts of formula (III) are either commercially available, prepared by known procedures or otherwise obtained using known chemistry. For example, the alkoxylated lignosulfonates may be obtained by alkoxylation of the lignosulfonates using known alkylene oxide reagents, such as ethylene oxide. In particular, the desirable alkoxylated lignosulfonate salts of formula (III) are those selected from the group consisting of ethoxylated lignosulfonates, propoxylated lignosulfonates and butoxylated lignosulfonates. Other useful alkoxylated lignosulfonate salts of formula (III) are those compounds resulting from for example mixed alkoxylation whereby the alkylene oxide units introduced vary or alternate for example between ethylene oxide and propylene oxide. The lignosulfonates which may be utilized for preparing the alkoxylated lignosulfonate salts of formula (III) are either commercially available, prepared by known procedures or otherwise obtained using known chemistry.

The lignosulfonates used to make the alkoxylated lignosulfonate salts of formula (III) are well known in the art, and are for example derived from the sulfite pulping of wood and by sulfonation of lignins derived from the kraft pulping of wood. The kraft lignin materials used are typically in the salt form (i.e., sodium, potassium, etc.). Typically, lignosulfonates may be obtained by sulfonation of spent sulfite liquors from wood conversion. It is preferable to use purified lignosulfonate material in which the sugars and other polysaccharide constituents have been partially or fully eliminated.

By “kraft lignin” it is meant a material typically recovered from alkaline pulping black liquors such as are produced in the kraft, soda and other well known alkaline pulping operations.

Typically, the alkoxylated lignosulfonate salts of formula (III) have a specific degree of sulfonation. The degree of sulfonation is a function of the amount of organically bound sulfur present in the material and may be determined by any appropriate method known to the skilled person. For example, sulfonation may be determined by calculating the total sulfur content minus the sum of the amount of sulfur present in the starting material, and the sulfur present in free sulfite and sulfate. The amount of free sulfite, free sulfate and total sulfur may be determined by any method known to the skilled person. The compound of formula (I) is preventively and/or curatively valuable active ingredient in the field of pest control, even at low rates of application, which have a very favorable biocidal spectrum and may be well-tolerated by warm-blooded species, fish and plants. The compound of formula (I) may have a beneficial safety profile towards non-target species, such as bees, and accordingly a good toxicity profile. The compound of formula (I) may act against all or individual developmental stages of normally sensitive, but also resistant pests, such as insects or representatives of the order Acarina. The insecticidal or acaricidal activity of the compound of formula (I) can manifest itself directly, i.e. in destruction of the pests, which takes place either immediately or only after some time has elapsed, for example during ecdysis, or indirectly, for example in a reduced oviposition and/or hatching rate.

Examples of the above-mentioned pests are:

from the order Acarina, for example,

Acalitus spp, Aculus spp, Acaricalus spp, Aceria spp, Acarus siro, Amblyomma spp., Argas spp., Boophilus spp., Brevipalpus spp., Bryobia spp, Calipitrimerus spp., Chorioptes spp., Dermanyssus gallinae, Dermatophagoides spp, Eotetranychus spp, Eriophyes spp., Hemitarsonemus spp, Hyalomma spp., Ixodes spp., Olygonychus spp, Ornithodoros spp., Polyphagotarsone latus, Panonychus spp., Phyllocoptruta oleivora, Phytonemus spp, Polyphagotarsonemus spp, Psoroptes spp., Rhipicephalus spp., Rhizoglyphus spp., Sarcoptes spp., Steneotarsonemus spp, Tarsonemus spp. and Tetranychus spp.,

from the order Anoplura, for example,

Haematopinus spp., Linognathus spp., Pediculus spp., Pemphigus spp. and Phylloxera spp.,

from the order Coleoptera, for example,

Agriotes spp., Amphimallon majale, Anomala orientalis, Anthonomus spp., Aphodius spp, Astylus atromaculatus, Ataenius spp, Atomaria linearis, Chaetocnema tibialis, Cerotoma spp, Conoderus spp, Cosmopolites spp., Cotinis nitida, Curculio spp., Cyclocephala spp, Dermestes spp., Diabrotica spp., Diloboderus abderus, Epilachna spp., Eremnus spp., Heteronychus arator, Hypothenemus hampei, Lagria vilosa, Leptinotarsa decemLineata, Lissorhoptrus spp., Liogenys spp, Maecolaspis spp, Maladera castanea, Megascelis spp, Melighetes aeneus, Melolontha spp., Myochrous armatus, Orycaephilus spp., Otiorhynchus spp., Phyllophaga spp, Phlyctinus spp., Popillia spp., Psylliodes spp., Rhyssomatus aubtilis, Rhizopertha spp., Scarabeidae, Sitophilus spp., Sitotroga spp., Somaticus spp, Sphenophorus spp, Sternechus subsignatus, Tenebrio spp., Tribolium spp. and Trogoderma spp.,

from the order Diptera, for example,

Aedes spp., Anopheles spp, Antherigona soccata, Bactrocea oleae, Bibio hortulanus, Bradysia spp, Calliphora erythrocephala, Ceratitis spp., Chrysomyia spp., Culex spp., Cuterebra spp., Dacus spp., Delia spp, Drosophila melanogaster, Fannia spp., Gastrophilus spp., Geomyza tripunctata, Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis spp, Rivelia quadrifasciata, Scatella spp, Sciara spp., Stomoxys spp., Tabanus spp., Tannia spp. and Tipula spp.,

from the order Hemiptera, for example,

Acanthocoris scabrator, Acrosternum spp, Adelphocoris lineolatus, Amblypelta nitida, Bathycoelia thalassina, Blissus spp, Cimex spp., Clavigralla tomentosicollis, Creontiades spp, Distantiella theobroma, Dichelops furcatus, Dysdercus spp., Edessa spp, Euchistus spp., Eurydema pulchrum, Eurygaster spp., Euschistus spp. (stinkbugs), Halyomorpha halys, Horcias nobilellus, Leptocorisa spp., Lygus spp, Margarodes spp, Murgantia histrionic, Neomegalotomus spp, Nesidiocoris tenuis, Nezara spp., Nysius simulans, Oebalus insularis, Piesma spp., Piezodorus spp, Rhodnius spp., Sahlbergella singularis, Scaptocoris castanea, Scotinophara spp., Thyanta spp, Triatoma spp., Vatiga illudens, Acyrthosium pisum, Adalges spp, Agalliana ensigera, Agonoscena targionii, Aleurodicus spp, Aleurocanthus spp, Aleurolobus barodensis, Aleurothrixus floccosus, Aleyrodes brassicae, Amarasca biguttula, Amritodus atkinsoni, Aonidiella spp., Aphididae, Aphis spp., Aspidiotus spp., Aulacorthum solani, Bactericera cockerelli, Bemisia spp, Brachycaudus spp, Brevicoryne brassicae, Cacopsylla spp, Cavariella aegopodii spp., Ceroplaster spp., Chrysomphalus aonidium, Chrysomphalus dictyospermi, Cicadella spp, Cofana spectra, Cryptomyzus spp, Cicadulina spp, Coccus hesperidum, Dalbulus maidis, Dialeurodes spp, Diaphorina citri, Diuraphis noxia, Dysaphis spp, Empoasca spp., Eriosoma larigerum, Erythroneura spp., Gascardia spp., Glycaspis brimblecombei, Hyadaphis pseudobrassicae, Hyalopterus spp, Hyperomyzus pallidus, Idioscopus clypealis, Jacobiasca lybica, Laodelphax spp., Lecanium corni, Lepidosaphes spp., Lopaphis erysimi, Lyogenys maidis, Macrosiphum spp., Mahanarva spp, Metcalfa pruinosa, Metopolophium dirhodum, Myndus crudus, Myzus spp., Neotoxoptera sp, Nephotettix spp., Nilaparvata spp., Nippolachnus piri Mats, Odonaspis ruthae, Oregma lanigera Zehnter, Parabemisia myricae, Paratrioza cockerelli, Parlatoria spp., Pemphigus spp., Peregrinus maidis, Perkinsiella spp, Phorodon humuli, Phylloxera spp, Planococcus spp., Pseudaulacaspis spp., Pseudococcus spp., Pseudatomoscelis seriatus, Psylla spp., Pulvinaria aethiopica, Quadraspidiotus spp., Quesada gigas, Recilia dorsalis, Rhopalosiphum spp., Saissetia spp., Scaphoideus spp., Schizaphis spp., Sitobion spp., Sogatella furcifera, Spissistilus festinus, Tarophagus Proserpina, Toxoptera spp, Trialeurodes spp, Tridiscus sporoboli, Trionymus spp, Trioza erytreae, Unaspis citri, Zygina flammigera, Zyginidia scutellaris,

from the order Hymenoptera, for example,

Acromyrmex, Arge spp, Atta spp., Cephus spp., Diprion spp., Diprionidae, Gilpinia polytoma, Hoplo-campa spp., Lasius spp., Monomorium pharaonis, Neodiprion spp., Pogonomyrmex spp, Slenopsis invicta, Solenopsis spp. and Vespa spp.,

from the order Isoptera, for example,

Coptotermes spp, Corniternes cumulans, Incisitermes spp, Macrotermes spp, Mastotermes spp, Microtermes spp, Reticulitermes spp., Solenopsis geminate

from the order Lepidoptera, for example,

Acleris spp., Adoxophyes spp., Aegeria spp., Agrotis spp., Alabama argillaceae, Amylois spp., Anticarsia gemmatalis, Archips spp., Argyresthia spp, Argyrotaenia spp., Autographa spp., Bucculatrix thurberiella, Busseola fusca, Cadra cautella, Carposina nipponensis, Chilo spp., Choristoneura spp., Chrysoteuchia topiaria, Clysia ambiguella, Cnaphalocrocis spp., Cnephasia spp., Cochylis spp., Coleophora spp., Colias lesbia, Cosmophila flava, Crambus spp, Crocidolomia binotalis, Cryptophlebia leucotreta, Cydalima perspectalis, Cydia spp., Diaphania perspectalis, Diatraea spp., Diparopsis castanea, Earias spp., Eldana saccharina, Ephestia spp., Epinotia spp, Estigmene acrea, Etiella zinckinella, Eucosma spp., Eupoecilia ambiguella, Euproctis spp., Euxoa spp., Feltia jaculiferia, Grapholita spp., Hedya nubiferana, Heliothis spp., Hellula undalis, Herpetogramma spp, Hyphantria cunea, Keiferia lycopersicella, Lasmopalpus lignosellus, Leucoptera scitella, Lithocollethis spp., Lobesia botrana, Loxostege bifidalis, Lymantria spp., Lyonetia spp., Malacosoma spp., Mamestra brassicae, Manduca sexta, Mythimna spp, Noctua spp, Operophtera spp., Orniodes indica, Ostrinia nubilalis, Pammene spp., Pandemis spp., Panolis flammea, Papaipema nebris, Pectinophora gossypiela, Perileucoptera coffeella, Pseudaletia unipuncta, Phthorimaea operculella, Pieris rapae, Pieris spp., Plutella xylostella, Prays spp., Pseudoplusia spp, Rachiplusia nu, Richia albicosta, Scirpophaga spp., Sesamia spp., Sparganothis spp., Spodoptera spp., Sylepta derogate, Synanthedon spp., Thaumetopoea spp., Tortrix spp., Trichoplusia ni, Tuta absoluta, and Yponomeuta spp.,

from the order Mallophaga, for example,

Damalinea spp. and Trichodectes spp.,

from the order Orthoptera, for example,

Blatta spp., Blattella spp., Gryllotalpa spp., Leucophaea maderae, Locusta spp., Neocurtilla hexadactyla, Periplaneta spp., Scapteriscus spp, and Schistocerca spp., from the order Psocoptera, for example,

Liposcelis spp.,

from the order Siphonaptera, for example,

Ceratophyllus spp., Ctenocephalides spp. and Xenopsylla cheopis,

from the order Thysanoptera, for example,

Calliothrips phaseoli, Frankliniella spp., Heliothrips spp, Hercinothrips spp., Parthenothrips spp, Scirtothrips aurantii, Sericothrips variabilis, Taeniothrips spp., Thrips spp,

from the order Thysanura, for example, Lepisma saccharina.

The pesticidal composition according to the invention can be used for controlling, i. e. containing or destroying, pests of the abovementioned type which occur in particular on plants, especially on useful plants and ornamentals in agriculture, in horticulture and in forests, or on organs, such as fruits, flowers, foliage, stalks, tubers or roots, of such plants, and in some cases even plant organs which are formed at a later point in time remain protected against these pests.

According to the invention “useful plants” typically comprise the following perennial or annual plants: grains such as cereals, e.g. barley, maize (corn), millet, oats, rice, rye, sorghum, triticale, tritordeum and wheat, amaranth, buckwheat, chia, quinoa, and canihua;

fruits and tree nuts such as grape vine (table and wine grapes), almond, apple, apricot, avocado, banana, blackberry, blueberry, breadfruit, cacao, cashew, cherimoya, cherry, chestnut (for nuts), chokeberry, citrus (including grapefruit, lime, lemon, orange, calamansi), coconut, coffee, cranberry, currant, date, feijoa fruit, fig, filbert (hazelnut), gooseberry, guava, kiwi, litchi, macadamia, mango, nectarine, olive, papaya, passion fruit, peach, pear, pecan, persimmon, pineapple, pistachio, plum (including prune), pomegranate, quince, raspberry, strawberry, suriname cherry, and walnut; vegetables such as artichoke, asparagus, bean (snap, green, dry, edible), beet (table), broccoli/broccoli raab, Brussels sprouts, cabbage (incl. Chinese), carrot, cauliflower, celeriac, celery, chickpeas, chive, collards (including kale), cucumber, edamame, eggplant, endive, pea (garden, dry, edible), garlic, horseradish, kohlrabi, leek, lentils, lettuce, melon, mushroom (cultivated), mustard and other greens, okra, onion, parsley, parsnip, pepper, sweet pepper, potato, prickly pear, pumpkin, radish, rhubarb, rutabaga, salsify, spinach, squash (summer and winter), sweet corn, sweet potato, Swiss chard, taro, tomato/tomatillo, turnip, and watermelon;

field crops such as sugar beet, sugarcane, tobacco, peanut, soybean;

oil seed crops such as oilseed rape (canola), mustard, camelina, crambe, sunflower, poppy, sesame, and safflower;

forage crops for example alfalfa, clover, cowpea, vetches, sainfoin, lupine, fodder beet, ryegrass, kentucky bluegrass, fescue, orchard grass; fiber crops such as cotton, flax, hemp, jute and sisal; forest plants including coniferous species e.g. larch, fir, or pine, temperate and tropical hardwoods e.g. oak, birch, beech, teak, or mahogany, and tree species in arid zones, e.g. eucalyptus tree; horticulture crops such as hops, maple (maple syrup), tea, natural rubber plants and turfgrass e.g. bentgrass, kentucky bluegrass, ryegrass, Fescues, bermudagrass, centipede grass, crested hairgrass, kikuyugrass, st. augustinegrass, zoysiagrass, dichondra, timothy grass, tufted hairgrass; floriculture, greenhouse and nursery plants including flowers, broad-leaved trees or evergreens as an example begonia, dahlia, geranium, impatiens, petunia, coleus, marigold, pansy, snapdragon, african violet, azalea, florist chrysanthemum, flowering bulbs, hydrangea, lily, orchid, poinsettia, rose, astilbe, coreopsis, delphinium, dianthus, heuchera, hosta, phlox, rudbeckia, salvia, vinca, columbine, daylily, garden chrysanthemum, ivy, ornamental grasses, peony, delphinium, gladiolus, iris, snapdragon, tulip, eucalyptus, pittosporum, fern, anthurium, dieffenbachia, dracaena, ficus, philodendron, spathipyllum, bromeliad, cacti, palm, balsam fir, blue spruce, douglas fir, fraser fir, noble fir, scotch pine, white pine, magnolia, ash, elm, flowering cherry, flowering plum, hawthorn, redbud, and serviceberry; propagative materials such as bare-root divisions, cuttings, liners, plug seedlings, seeds, tissue-cultured plantlets, and prefinished plants;

culinary herbs and spices for example allspice, Angelica spp., anise, annatto, arugula, asafetida, basil (all types), bay (cultivated), bladder wrack (seaweed), Bolivian coriander, borage, calendula (herbal uses), candle nut, caper, caraway, cardamom, cassia spice, cinnamon, clary sage, cloves, catnip, chamomile, chervil, chicory, cicely, cilantro, comfrey, coriander, cress, cumin, curry, dill, fennel, fenugreek, file (cultivated), fingerroot, galangal, ginger, hops, horehound, hyssop, lavender, lemon balm, lemon thyme, lovage, mace, mahlab, malabathrum, marjoram, mint (all types), mugwort, nutmeg, oregano, orris root, paprika, parsley, pepper, rosemary, rue, saffron, sage (all types), savory (all types), sorrel, tarragon, thyme, turmeric, vanilla, wasabi, and watercress; and medicinal herbs for example arum, Artemisia spp., astralagus, boldo, comfrey, coneflower, fenugreek, feverfew, foxglove, Ginkgo biloba, ginseng, goat's rue, goldenseal, gypsywort, horehound, horsetail, lavender, liquorice, marshmallow, mullein, nettle, passionflower, patchouli, pennyroyal, pokeweed, skullcap, sorrel, St. John's wort, senna, sow thistle, stevia, tansy, witch hazel, wood betony, wormwood, yarrow, yerba buena, and Ylang Ylang.

This list does not represent any limitation, however, preferably, the useful plant may be selected from the group consisting of cereals (e.g. barley, corn, rice, rye, sorghum, oats, wheat), vegetables (e.g. bean, cucumber, eggplant, lettuce, melon, pumpkin, spinach, sweet pepper, watermelon), field crops (e.g. sugar beet, peanut), oil seed crops (e.g. sunflower, canola), forage crops (e.g. alfalfa) and fiber crops (e.g. cotton).

The pesticidal composition according to the invention may especially be suitable for controlling pests including soil-dwelling, early leaf feeding and sucking insects such as wire worms, aphids, thrips, leaf and stem feeding Coleoptera species such as Atomaria spp. and flea beetle and some Lepidoptera species such as Alabama spp. on cereals (e.g. barley, corn, rice, rye, sorghum, oats, wheat), vegetables (e.g. bean, cucumber, eggplant, lettuce, melon, pumpkin, spinach, sweet pepper, watermelon), field crops (e.g. sugar beet, peanut), oil seed crops (e.g. sunflower, canola), forage crops (e.g. alfalfa) and fiber crops (e.g. cotton).

The active ingredients according to the invention are further especially suitable for controlling Mamestra (preferably in vegetables), Cydia pomonella (preferably in apples), Empoasca (preferably in vegetables, vineyards), Leptinotarsa (preferably in potatos) and Chilo supressalis (preferably in rice).

In a further aspect, the invention may also relate to a method of controlling damage to plant and parts thereof by plant parasitic nematodes (Endoparasitic-, Semiendoparasitic- and Ectoparasitic nematodes), especially plant parasitic nematodes such as root knot nematodes, Meloidogyne hapla, Meloidogyne incognita, Meloidogyne javanica, Meloidogyne arenaria and other Meloidogyne species, cyst-forming nematodes, Globodera rostochiensis and other Globodera species, Heterodera avenae, Heterodera glycines, Heterodera schachtii, Heterodera trifolii, and other Heterodera species, Seed gall nematodes, Anguina species, Stem and foliar nematodes, Aphelenchoides species, Sting nematodes, Belonolaimus longicaudatus and other Belonolaimus species, Pine nematodes, Bursaphelenchus xylophilus and other Bursaphelenchus species, Ring nematodes, Criconema species, Criconemella species, Criconemoides species, Mesocriconema species, Stem and bulb nematodes, Ditylenchus destructor, Ditylenchus dipsaci and other Ditylenchus species, Awl nematodes, Dolichodorus species, Spiral nematodes, Heliocotylenchus multicinctus and other Helicotylenchus species, Sheath and sheathoid nematodes, Hemicycliophora species and Hemicriconemoides species, Hirshmanniella species, Lance nematodes, Hoploaimus species, false rootknot nematodes, Nacobbus species, Needle nematodes, Longidorus elongatus and other Longidorus species, Pin nematodes, Pratylenchus species, Lesion nematodes, Pratylenchus neglectus, Pratylenchus penetrans, Pratylenchus curvitatus, Pratylenchus goodeyi and other Pratylenchus species, Burrowing nematodes, Radopholus similis and other Radopholus species, Reniform nematodes, Rotylenchus robustus, Rotylenchus reniformis and other Rotylenchus species, Scutellonema species, Stubby root nematodes, Trichodorus primitivus and other Trichodorus species, Paratrichodorus species, Stunt nematodes, Tylenchorhynchus claytoni, Tylenchorhynchus dubius and other Tylenchorhynchus species, Citrus nematodes, Tylenchulus species, Dagger nematodes, Xiphinema species, and other plant parasitic nematode species, such as Subanguina spp., Hypsoperine spp., Macroposthonia spp., Melinius spp., Punctodera spp., and Quinisulcius spp.

The pesticidal composition of the invention may also have activity against the molluscs. Examples of which include, for example, Ampullariidae, Arion (A. ater, A. circumscriptus, A. hortensis, A. rufus), Bradybaenidae (Bradybaena fruticum), Cepaea (C. hortensis, C. Nemoralis), ochlodina, Deroceras (D. agrestis, D. empiricorum, D. laeve, D. reticulatum), Discus (D. rotundatus), Euomphalia, Galba (G. trunculata), Helicelia (H. itala, H. obvia), Helicidae Helicigona arbustorum), Helicodiscus, Helix (H. aperta), Limax (L. cinereoniger, L. flavus, L. marginatus, L. maximus, L. tenellus), Lymnaea, Milax (M. gagates, M. marginatus, M. sowerbyi), Opeas, Pomacea (P. canaticulata), Vallonia and Zanitoides. Compounds according to formula (I) may find utility in controlling resistant populations of insects previously sensitive to the neonicotinoid class of pesticidal (insecticidal) agents (the “neonicotinoids”). Such neonicotinoid-resistant insects may include insects from the order Lepidoptera or Hemiptera, in particular from the family Aphididae.

The neonicotinoids represent a well-known class of insecticides introduced to the market since the commercialization of pyrethroids (Nauen & Denholm, 2005: Archives of Insect Biochemistry and Physiology 58:200-215) and are extremely valuable insect control agents, not least because they had exhibited little or no cross-resistance to older insecticide classes, which suffer markedly from resistance problems. However, reports of insect resistance to the neonicotinoid class of insecticides are on the increase. The increase in resistance of such insects to neonicotinoid insecticides thus poses a significant threat to the cultivation of a number of commercially important crops, fruits and vegetables, and there is thus a need to find alternative insecticides capable of controlling neonicotinoid resistant insects (i.e. to find insecticides that do not exhibit any cross-resistance with the neonicotinoid class).

Resistance may be defined as “a heritable change in the sensitivity of a pest population that is reflected in the repeated failure of a product containing an insecticidal active ingredient to achieve the expected level of control when used according to the label recommendation for that pest species” (IRAC). Cross-resistance occurs when resistance to one insecticide confers resistance to another insecticide via the same biochemical mechanism. This can happen within insecticide chemical groups or between insecticide chemical groups. Cross-resistance may occur even if the resistant insect has never been exposed to one of the chemical classes of insecticide.

Two of the major mechanisms for neonicotinoid resistance include:
(i) Target site resistance, whereby resistance is associated with replacement of one or more amino acids in the insecticide target protein (i.e. the nicotinic acetylcholine receptor); and (ii) Metabolic resistance, such as enhanced oxidative detoxification of neonicotinoids due to overexpression of monooxygenases.

For general review on insect resistance to neonicotinoid insecticides see, for example, Pesticide Biochemistry and Physiology (2015), 121, 78-87 or Advances in Experimental Medicine and Biology (2010), 683(Insect Nicotinic Acetylcholine Receptors), 75-83. The cytochrome P450 monooxygenases are an important metabolic system involved in the detoxification/activation of xenobiotics. As such, P450 monooxygenases play an important role in insecticide resistance.

P450 monooxygenases have such a phenomenal array of metabolisable substrates because of the presence of numerous P450s (60-111) in each species, as well as the broad substrate specificity of some P450s. Studies of monooxygenase-mediated resistance have indicated that resistance can be due to increased expression of one P450 (via increased transcription) involved in detoxification of the insecticide and might also be due to a change in the structural gene itself. As such, metabolic cross-resistance mechanisms affect not only insecticides from the given class (e.g. neonicotinoids) but also seemingly unrelated insecticides. For example, cross-resistance relationships between the neonicotinoids and pymetrozine in Bemisia tabaci have been reported by Gorman et al (Pest Management Science 2010, p.1186-1190). Or for example, for evidence on detoxification via P450, see, for example, Harrop, Thomas W R and al. Pest Management Science (2018), 74(7), p1616-1622 and cited references.

Target site resistance of nicotinoids are well studied and it has been shown that modification active site of nicotinic acetylcholine receptor confers the resistance to nicotinoids. For example, see Bass et al BMC Neuroscience (2011), 12, p 51, Pest Management Science (2018), 74(6), 1297-1301.

The term “crops” is to be understood as including also crop plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, for example insecticidal proteins from Bacillus cereus or Bacillus popilliae, or insecticidal proteins from Bacillus thuringiensis, such as 6-endotoxins, e.g. Cry1Ab, Cry1Ac, Cry1F, Cry1Fa2, Cry2Ab, Cry3A, Cry3Bb1 or Cry9C, or vegetative insecticidal proteins (Vip), e.g. Vip1, Vip2, Vip3 or Vip3A, or insecticidal proteins of bacteria colonising nematodes, for example Photorhabdus spp. or Xenorhabdus spp., such as Photorhabdus luminescens, Xenorhabdus nematophilus, toxins produced by animals, such as scorpion toxins, arachnid toxins, wasp toxins and other insect-specific neurotoxins, toxins produced by fungi, such as Streptomycetes toxins, plant lectins, such as pea lectins, barley lectins or snowdrop lectins, agglutinins, proteinase inhibitors, such as trypsin inhibitors, serine protease inhibitors, patatin, cystatin, papain inhibitors, ribosome-inactivating proteins (RIP), such as ricin, maize-RIP, abrin, luffin, saporin or bryodin, steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention, there are to be understood by 6-endotoxins, for example Cry1Ab, Cry1Ac, Cry1F, Cry1Fa2, Cry2Ab, Cry3A, Cry3Bb1 or Cry9C, or vegetative insecticidal proteins (Vip), for example Vip1, Vip2, Vip3 or Vip3A, expressly also hybrid toxins, truncated toxins and modified toxins. Hybrid toxins are produced recombinantly by a new combination of different domains of those proteins (see, for example, WO 02/15701). Truncated toxins, for example a truncated Cry1Ab, are known. In the case of modified toxins, one or more amino acids of the naturally occurring toxin are replaced. In such amino acid replacements, preferably non-naturally present protease recognition sequences are inserted into the toxin, such as, for example, in the case of Cry3A055, a cathepsin-G-recognition sequence is inserted into a Cry3A toxin (see WO 03/018810). Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. Cry1-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and moths (Lepidoptera).

Transgenic plants containing one or more genes that code for an insecticidal resistance and express one or more toxins are known and some of them are commercially available. Examples of such plants are: YieldGard® (maize variety that expresses a Cry1Ab toxin), YieldGard Rootworm® (maize variety that expresses a Cry3Bb1 toxin), YieldGard Plus® (maize variety that expresses a Cry1Ab and a Cry3Bb1 toxin), Starlink® (maize variety that expresses a Cry9C toxin), Herculex I® (maize variety that expresses a Cry1Fa2 toxin and the enzyme phosphinothricine N-acetyltransferase (PAT) to achieve tolerance to the herbicide glufosinate ammonium), NuCOTN 33B® (cotton variety that expresses a Cry1Ac toxin), Bollgard I® (cotton variety that expresses a Cry1Ac toxin), Bollgard II®(cotton variety that expresses a Cry1Ac and a Cry2Ab toxin), VipCot® (cotton variety that expresses a Vip3A and a Cry1Ab toxin), NewLeaf® (potato variety that expresses a Cry3A toxin), NatureGard®, Agrisure® GT Advantage (GA21 glyphosate-tolerant trait), Agrisure® CB Advantage (Bt11 corn borer (CB) trait) and Protecta®.

Further examples of such transgenic crops are:
1. Bt11 Maize from Syngenta Seeds SAS, Chemin de I'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated Cry1Ab toxin. Bt11 maize also transgenically expresses the enzyme PAT to achieve tolerance to the herbicide glufosinate ammonium.
2. Bt176 Maize from Syngenta Seeds SAS, Chemin de I'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a Cry1Ab toxin. Bt176 maize also transgenically expresses the enzyme PAT to achieve tolerance to the herbicide glufosinate ammonium.
3. MIR604 Maize from Syngenta Seeds SAS, Chemin de I'Hobit 27, F-31 790 St. Sauveur, France, registration number C/FR/96/05/10. Maize which has been rendered insect-resistant by transgenic expression of a modified Cry3A toxin. This toxin is Cry3A055 modified by insertion of a cathepsin-G-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a Cry3Bb1 toxin and has resistance to certain Coleoptera insects.
5. IPC 531 Cotton from Monsanto Europe S.A. 270-272 Avenue de Tervuren, B-1150 Brussels, Belgium, registration number C/ES/96/02.
6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.
7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a Cry1Ab toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit und Nachhaltigkeit, Zentrum BATS, Clarastrasse 13, 4058 Basel, Switzerland) Report 2003, (http://bats.ch).

The term “crops” is to be understood as including also crop plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818 and EP-A-0 353 191. The methods of producing such transgenic plants are generally known to the person skilled in the art and are described, for example, in the publications mentioned above.

Crops may also be modified for enhanced resistance to fungal (for example Fusarium, Anthracnose, or Phytophthora), bacterial (for example Pseudomonas) or viral (for example potato leafroll virus, tomato spotted wilt virus, cucumber mosaic virus) pathogens.

Crops also include those that have enhanced resistance to nematodes, such as the soybean cyst nematode.

Crops that are tolerance to abiotic stress include those that have enhanced tolerance to drought, high salt, high temperature, chill, frost, or light radiation, for example through expression of NF-YB or other proteins known in the art.

Antipathogenic substances which can be expressed by such transgenic plants include, for example, ion channel blockers, such as blockers for sodium and calcium channels, for example the viral KP1, KP4 or KP6 toxins, stilbene synthases, bibenzyl synthases, chitinases, glucanases, the so-called “pathogenesis-related proteins” (PRPs, see e.g. EP-A-0 392 225), antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

Further areas of use of the compositions according to the invention are the protection of stored goods and store ambients and the protection of raw materials, such as wood, textiles, floor coverings or buildings, and also in the hygiene sector, especially the protection of humans, domestic animals and productive livestock against pests of the mentioned type.

The present invention also provides a method for controlling pests (such as mosquitoes and other disease vectors, see also http://www.who.int/malaria/vector control/irs/en/). In one embodiment, the method for controlling pests comprises applying the composition of the invention to the target pests, to their locus or to a surface or substrate by brushing, rolling, spraying, spreading or dipping. By way of example, an IRS (indoor residual spraying) application of a surface such as a wall, ceiling or floor surface is contemplated by the method of the invention. In another embodiment, it is contemplated to apply such composition to a substrate such as non-woven or a fabric material in the form of (or which can be used in the manufacture of) netting, clothing, bedding, curtains and tents. A further object of the invention is therefore a substrate selected from nonwoven and fabric material comprising a composition which contains a compound of formula (I).

In one embodiment, the method for controlling such pests comprises applying a pesticidally effective amount of the pesticidal composition of the invention to the target pests, to their locus, or to a surface or substrate so as to provide effective residual pesticidal activity on the surface or substrate. Such application may be made by brushing, rolling, spraying, spreading or dipping the composition of the invention. By way of example, an IRS application of a surface such as a wall, ceiling or floor surface is contemplated by the method of the invention so as to provide effective residual pesticidal activity on the surface. In another embodiment, it is contemplated to apply such composition for residual control of pests on a substrate such as a fabric material in the form of (or which can be used in the manufacture of) netting, clothing, bedding, curtains and tents.

The term “effective amount” when used used in context of parasites in or on an animal refers to the amount or dose of the compound of the invention, or a salt thereof, which, upon single or multiple dose administration to the animal, provides the desired effect in or on the animal. The effective amount can be readily determined by the attending diagnostician, as one skilled in the art, by the use of known techniques and by observing results obtained under analogous circumstances. In determining the effective amount a number of factors are considered by the attending diagnostician, including, but not limited to: the species of mammal; its size, age, and general health; the parasite to be controlled and the degree of infestation; the specific disease or disorder involved; the degree of or involvement or the severity of the disease or disorder; the response of the individual; the particular compound administered; the mode of administration; the bioavailability characteristics of the preparation administered; the dose regimen selected; the use of concomitant medication; and other relevant circumstances.

Substrates including non-woven, fabrics or netting to be treated may be made of natural fibres such as cotton, raffia, jute, flax, sisal, hessian, or wool, or synthetic fibres such as polyamide, polyester, polypropylene, polyacrylonitrile or the like. The polyesters are particularly suitable. The methods of textile treatment are known, e.g. WO 2008/151984, WO 03/034823, U.S. Pat. No. 5,631,072, WO 2005/64072, WO 2006/128870, EP 1724392, WO 2005113886 or WO 2007/090739.

Further areas of use of the compositions according to the invention are the field of tree injection/trunk treatment for all ornamental trees as well all sort of fruit and nut trees.

In the field of tree injection/trunk treatment, the composition according to the present invention is especially suitable against wood-boring insects from the order Lepidoptera as mentioned above and from the order Coleoptera, especially against woodborers listed in the following Table:

TABLE A
Examples of exotic woodborers of economic importance.

| Family | Species | Host or Crop Infested |
|---|---|---|
| Buprestidae | Agrilus planipennis | Ash |
| Cerambycidae | Anoplura glabripennis | Hardwoods |
| Scolytidae | Xylosandrus crassiusculus | Hardwoods |
| | X. mutilatus | Hardwoods |
| | Tomicus piniperda | Conifers |

TABLE B
Examples of native woodborers of economic importance.

| Family | Species | Host or Crop Infested |
|---|---|---|
| Buprestidae | Agrilus anxius | Birch |
| | Agrilus politus | Willow, Maple |
| | Agrilus sayi | Bayberry, Sweetfern |
| | Agrilus vittaticollis | Apple, Pear, Cranberry, |
| | | Serviceberry, Hawthorn |
| | Chrysobothris femorata | Apple, Apricot, Beech, Boxelder, |
| | | Cherry, Chestnut, Currant, Elm, |
| | | Hawthorn, Hackberry, Hickory, |
| | | Horsechestnut, Linden, Maple, |
| | | Mountain-ash, Oak, Pecan, Pear, |
| | | Peach, Persimmon, Plum, Poplar, |
| | | Quince, Redbud, Serviceberry, |
| | | Sycamore, Walnut, Willow |
| | Texania campestris | Basswood, Beech, Maple, Oak, |
| | | Sycamore, Willow, Yellow-poplar |
| Cerambycidae | Goes pulverulentus | Beech, Elm, Nuttall, Willow, Black |
| | | oak, Cherrybark oak, Water oak, |
| | | Sycamore |
| | Goes tigrinus | Oak |
| | Neoclytus acuminatus | Ash, Hickory, Oak, Walnut, Birch, |
| | | Beech, Maple, Eastern |
| | | hophornbeam, Dogwood, |
| | | Persimmon, Redbud, Holly, |
| | | Hackberry, Black locust, |
| | | Honeylocust, Yellow-poplar, |
| | | Chestnut, Osage-orange, Sassafras, |
| | | Lilac, Mountain-mahogany, Pear, |
| | | Cherry, Plum, Peach, Apple, Elm, |
| | | Basswood, Sweetgum |
| | Neoptychodes trilineatus | Fig, Alder, Mulberry, Willow, Netleaf |
| | | hackberry |
| | Oberea ocellata | Sumac, Apple, Peach, Plum, Pear, |
| | | Currant, Blackberry |
| | Oberea tripunctata | Dogwood, Viburnum, Elm, |
| | | Sourwood, Blueberry, |
| | | Rhododendron, Azalea, Laurel, |
| | | Poplar, Willow, Mulberry |
| | Oncideres cingulata | Hickory, Pecan, Persimmon, Elm, |
| | | Sourwood, Basswood, Honeylocust, |
| | | Dogwood, Eucalyptus, Oak, |
| | | Hackberry, Maple, Fruit trees |
| | Saperda calcarata | Poplar |
| | Strophiona nitens | Chestnut, Oak, Hickory, Walnut, |
| | | Beech, Maple |
| Scolytidae | Corthylus columbianus | Maple, Oak, Yellow-poplar, Beech, |
| | | Boxelder, Sycamore, Birch, |
| | | Basswood, Chestnut, Elm |
| | Dendroctonus frontalis | Pine |
| | Dryocoetes betulae | Birch, Sweetgum, Wild cherry, |
| | | Beech, Pear |
| | Monarthrum fasciatum | Oak, Maple, Birch, Chestnut, |
| | | Sweetgum, Blackgum, Poplar, |
| | | Hickory, Mimosa, Apple, Peach, Pine |
| | Phloeotribus liminaris | Peach, Cherry, Plum, Black cherry, |
| | | Elm, Mulberry, Mountain-ash |
| | Pseudopityophthorus pruinosus | Oak, American beech, Black cherry, |
| | | Chickasaw plum, Chestnut, Maple, |
| | | Hickory, Hornbeam, Hophornbeam |
| Sesiidae | Paranthrene simulans | Oak, American chestnut |
| | Sannina uroceriformis | Persimmon |
| | Synanthedon exitiosa | Peach, Plum, Nectarine, Cherry, |
| | | Apricot, Almond, Black cherry |
| | Synanthedon pictipes | Peach, Plum, Cherry, Beach, Black |
| | | Cherry |
| | Synanthedon rubrofascia | Tupelo |
| | Synanthedon scitula | Dogwood, Pecan, Hickory, Oak, |
| | | Chestnut, Beech, Birch, Black cherry, |
| | | Elm, Mountain-ash, Viburnum, |
| | | Willow, Apple, Loquat, Ninebark, |
| | | Bayberry |
| | Vitacea polistiformis | Grape |

The pesticidal composition of the present invention may be also used to control any insect pests that may be present in turfgrass, including for example beetles, caterpillars, fire ants, ground pearls, millipedes, sow bugs, mites, mole crickets, scales, mealybugs ticks, spittlebugs, southern chinch bugs and white grubs. The present invention may be used to control insect pests at various stages of their life cycle, including eggs, larvae, nymphs and adults.

In particular, the pesticidal composition of the present invention may be used to control insect pests that feed on the roots of turfgrass including white grubs (such as Cyclocephala spp. (e.g. masked chafer, C. lurida), Rhizotrogus spp. (e.g. European chafer, R. majalis), Cotinus spp. (e.g. Green June beetle, C. nitida), Popillia spp. (e.g. Japanese beetle, P. japonica), Phyllophaga spp. (e.g. May/June beetle), Ataenius spp. (e.g. Black turfgrass ataenius, A. spretulus), Maladera spp. (e.g. Asiatic garden beetle, M. castanea) and Tomarus spp.), ground pearls (Margarodes spp.), mole crickets (tawny, southern, and short-winged, Scapteriscus spp., Gryllotalpa africana) and leatherjackets (European crane fly, Tipula spp.).

The pesticidal composition of the present invention may also be used to control insect pests of turfgrass that are thatch dwelling, including armyworms (such as fall armyworm Spodoptera frugiperda, and common armyworm Pseudaletia unipuncta), cutworms, billbugs (Sphenophorus spp., such as S. venatus verstitus and S. parvulus), and sod webworms (such as Crambus spp. and the tropical sod webworm, Herpetogramma phaeopteralis).

The pesticidal composition of the present invention may also be used to control insect pests of turfgrass that live above the ground and feed on the turfgrass leaves, including chinch bugs (such as southern chinch bugs, Blissus insularis), Bermudagrass mite (Eriophyes cynodoniensis), rhodesgrass mealybug (Antonina graminis), two-lined spittlebug (Propsapia bicincta), leafhoppers, cutworms (Noctuidae family), and greenbugs.

The pesticidal composition of the present invention may also be used to control other pests of turfgrass such as red imported fire ants (Solenopsis invicta) that create ant mounds in turf.

In the hygiene sector, the compositions according to the invention are active against ectoparasites such as hard ticks, soft ticks, mange mites, harvest mites, flies (biting and licking), parasitic fly larvae, lice, hair lice, bird lice and fleas.

Examples of such parasites are:

Of the order Anoplurida: Haematopinus spp., Linognathus spp., Pediculus spp. and Phtirus spp., Solenopotes spp.,

Of the order Mallophagida: Trimenopon spp., Menopon spp., Trinoton spp., Bovicola spp., Werneckiella spp., Lepikentron spp., Damalina spp., Trichodectes spp. and Felicola spp.,

Of the order Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp. and Melophagus spp.,

Of the order Siphonapterida, for example Pulex spp., Ctenocephalides spp., Xenopsylla spp., Ceratophyllus spp.,

Of the order Heteropterida, for example Cimex spp., Triatoma spp., Rhodnius spp., Panstrongylus spp.,

Of the order Blattarida, for example Blatta orientalis, Periplaneta americana, Blattelager manica and Supella spp.,

Of the subclass Acaria (Acarida) and the orders Meta- and Meso-stigmata, for example Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp. and Varroa spp.,

Of the orders Actinedida (Prostigmata) and Acaridida (Astigmata), for example Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp. and Laminosioptes spp.

The pesticidal composition according to the invention is also suitable for protecting against insect infestation in the case of materials such as wood, textiles, plastics, adhesives, glues, paints, paper and card, leather, floor coverings and buildings.

The pesticidal composition according to the invention can be used, for example, against the following pests: beetles such as Hylotrupes bajulus, Chlorophorus pilosis, Anobium punctatum, Xestobium rufovillosum, Ptilinuspecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthesrugicollis, Xyleborus spec., Tryptodendron spec., Apate monachus, Bostrychus capucins, Heterobostrychus brunneus, Sinoxylon spec. and Dinoderus minutus, and also hymenopterans such as Sirexjuvencus, Urocerus gigas, Urocerus gigas taignus and Urocerus augur, and termites such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis and Coptotermes formosanus, and bristletails such as Lepisma saccharina.

The compound of formula (I) can be used as pesticidal agent in unmodified form, but it is generally formulated into compositions in various ways using formulation adjuvants or additives, such as carriers, solvents and surface-active substances.

The pesticidal composition of the invention can be in various physical forms, e.g. in the form of dusting powders, gels, wettable powders, water-dispersible granules, water-dispersible tablets, effervescent pellets, suspension concentrates, flowable concentrates for seed treatment, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such compositions can either be used directly or diluted prior to use. The dilutions can be made, for example, with water, liquid fertilisers, micronutrients, biological organisms, oil or solvents.

Preferably, the pesticidal composition of the invention is a flowable concentrate for seed treatment.

The term “flowable concentrate for seed treatment” is intended to denote a formulation wherein one or more solid active ingredients are dispersed in water, usually at high concentration.

The finely ground combination is intimately mixed with the adjuvants, giving a flowable concentrate for seed treatment from which suspensions of any desired dilution can be obtained by dilution with water.

Using such dilutions, living plants as well as plant propagation material can be treated and protected against infestation by microorganisms, by spraying, pouring or immersion.

The compositions of the invention can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

One or more active ingredients can also be contained in very fine microcapsules. Microcapsules contain the compound of formula (I) and, optionally, one or more ather active ingredients in a porous carrier. This enables the active ingredients to be released into the environment in controlled amounts (e.g. slow-release). Microcapsules usually have a diameter of from 0.1 to 500 microns. They contain the compound of formula (I) and, optionally, one or more other active ingredients in an amount of about from 25% to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the composition according to the invention are known per se.

As liquid carriers there may be used any of water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, glycerol, N-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

Further adjuvants that can be used in formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The compositions according to the invention can include an additive comprising an oil of vegetable or animal origin, a mineral oil, alkyl esters of such oils or mixtures of such oils and oil derivatives. The amount of oil additive in the composition according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C₈-C₂₂ fatty acids, especially the methyl derivatives of C₁₂-C₁₈ fatty acids, for example the methyl esters of lauric acid, palmitic acid and oleic acid (methyl laurate, methyl palmitate and methyl oleate, respectively). Many oil derivatives are known from the Compendium of Herbicide Adjuvants, 10^{th} Edition, Southern Illinois University, 2010.

Whereas commercial products may preferably be formulated as concentrates, the end user will normally employ dilute formulations.

The composition according to the invention can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The application methods for the composition of the invention, that is the methods of controlling pests of the abovementioned type, such as by spraying, atomizing, dusting, brushing, dressing, scattering or pouring, and the use of the composition of the invention for controlling pests of the abovementioned type are other subjects of the invention.

The rates of application vary within wide limits and depend on the nature of the soil, the method of application, the crop plant, the pest to be controlled, the prevailing climatic conditions, and other factors governed by the method of application, the time of application and the target crop. As a general guideline, the pesticidal composition of the invention may be applied at a rate of from 1 to 2000 I/ha, especially from 10 to 1000 I/ha. The rate of application per hectare is generally 1 to 2000 g of active ingredient per hectare, in particular 10 to 1000 g/ha, preferably 10 to 600 g/ha.

The activity of the pesticidal composition according to the invention can be broadened considerably, and adapted to prevailing circumstances, by adding other insecticidally, acaricidally and/or fungicidally active ingredients. The mixtures of the compound of formula (I) with other insecticidally, acaricidally and/or fungicidally active ingredients may also have further surprising advantages which can also be described, in a wider sense, as synergistic activity. For example, better tolerance by plants, reduced phytotoxicity, insects can be controlled in their different development stages or better behaviour during their production, for example during grinding or mixing, during their storage or during their use. A preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (soil application). In the case of paddy rice crops, such granules can be metered into the flooded paddy-field.

The composition of the invention is suitable for the protection of plant propagation material, for example seeds, such as fruit, tubers or kernels, or nursery plants, against pests of the abovementioned type. The propagation material can be treated with the composition prior to planting, for example seed can be treated prior to sowing. Alternatively, the composition can be applied to seed kernels (coating), either by soaking the kernels in a liquid composition or by applying a layer of a solid composition. It is also possible to apply the composition when the propagation material is planted to the site of application, for example into the seed furrow during drilling. These treatment methods for plant propagation material and the plant propagation material thus treated are further subjects of the invention. Typical treatment rates would depend on the plant and pest/fungi to be controlled and are generally between 1 to 200 grams per 100 kg of seeds, preferably between 5 to 150 grams per 100 kg of seeds, such as between 10 to 100 grams per 100 kg of seeds.

The term seed embraces seeds and plant propagules of all kinds including but not limited to true seeds, seed pieces, suckers, corns, bulbs, fruit, tubers, grains, rhizomes, cuttings, cut shoots and the like and means in a preferred embodiment true seeds.

The present invention also comprises seeds coated or treated with or containing a compound of formula (I). The term “coated or treated with and/or containing” generally signifies that the active ingredient is for the most part on the surface of the seed at the time of application, although a greater or lesser part of the ingredient may penetrate into the seed material, depending on the method of application. When the said seed product is (re)planted, it may absorb the active ingredient. In an embodiment, the present invention makes available a plant propagation material adhered thereto with a compound of formula (I).

Seed treatment comprises all suitable seed treatment techniques known in the art, such as seed dressing, seed coating, seed dusting, seed soaking and seed pelleting. The seed treatment application of the pesticidal composition of the invention can be carried out by any known methods, such as spraying or by dusting the seeds before sowing or during the sowing/planting of the seeds.

A further aspect is a plant propagation material comprising by way of treatment or coating a compound of formula (I) and, optionally, a colour pigment.

In each aspect and embodiment of the invention, “consisting essentially” and inflections thereof are a preferred embodiment of “comprising” and its inflections, and “consisting of” and inflections thereof are a preferred embodiment of “consisting essentially of” and its inflections.

The disclosure in the present application makes available each and every combination of embodiments disclosed herein.

The following Examples further illustrate, but do not limit, the invention.

### EXAMPLES

### Example 1

An aqueous flowable concentrate for seed treatment according to the invention containing the compound of formula (I) as active ingredient was prepared according to the following formulation:

| | % [by |
|---|---|
| Composition 1 | weight] |
| Thiamethoxam | 47.6% |
| Polyoxypropylene-polyoxypropylene block copolymer | 2.1% |
| HO—(CH₂CH₂O)₈₀—(CH(CH₃)CH₂O)₃₀—(CH₂CH₂O)₈₀—H | |
| Ethoxylated lignosulfonate sodium salt | 3.4% |
| (degree of sulfonation: 1.2 moles/Kg) | |
| Smectite clay | 1% |
| Xanthan gum | 0.11% |
| Dispersant | 1.4% |
| Liquid carrier | 6% |
| Solid carrier | 1% |
| Preservative | 0.2% |
| Antifoam | 0.1% |
| Water | up to |
| | 100% |

The above ingredients were formulated as follows:
(1) preparing a xanthan gum gel;
(2) preparing an aqueous millbase containing the compound of formula (I);
(3) grinding the millbase from (1) through a wet bead mill to a fine particle size; and
(4) adding the remaining ingredients followed by mixing until a uniform composition is obtained.

Non-limiting examples of block copolymers of ethylene oxide and propylene oxide of formula (II) suitable for use in the pesticidal composition of Example 1 include, for instance, surfactants which are commercially available under the trademark name PLURONIC® F68.

### Example 2

An aqueous flowable concentrate for seed treatment containing the compound of formula (I) as active ingredient was prepared according to the procedure as set forth in Example 1 but without the clay (composition 2).

### Comparative Example 1

An aqueous flowable concentrate for seed treatment containing the compound of formula (I) as active ingredient was prepared according to the procedure as set forth in Example 1 but replacing the block copolymer of ethylene oxide and propylene oxide of formula (II) with HO—(CH₂CH₂O)₆₁—(CH(CH₃)CH₂O)₄₀—(CH₂CH₂O)₆₁—H, wherein the polyoxyethylene:polyoxypropylene chain length ratio is outside the range from 4:1 to 7:1 (comparative composition 1):

| | % [by |
|---|---|
| Comparative composition 1 | weight] |
| Thiamethoxam | 47.6% |
| Polyoxypropylene-polyoxypropylene block copolymer | 2.1% |
| HO—(CH₂CH₂O)₆₁—(CH(CH₃)CH₂O)₄₀—(CH₂CH₂O)₆₁—H | |
| Ethoxylated lignosulfonate sodium salt | 3.4% |
| (degree of sulfonation: 1.2 moles/Kg) | |
| Smectite clay | 1% |
| Xanthan gum | 0.11% |
| Dispersant | 1.4% |
| Liquid carrier | 6% |
| Solid carrier | 1% |
| Preservative | 0.2% |
| Antifoam | 0.1% |
| Water | up to |
| | 100% |

Non-limiting examples of block copolymers of ethylene oxide and propylene oxide suitable for use in the pesticidal composition of Comparative Example 1 include, for instance, surfactants which are commercially available under the trademark name PLURONIC® F87.

### Comparative Example 2

An aqueous flowable concentrate for seed treatment containing the compound of formula (I) as active ingredient was prepared according to the procedure as set forth in Example 1 but replacing the block copolymer of ethylene oxide and propylene oxide of formula (II) with HO—(CH₂CH₂O)₈—(CH(CH₃)CH₂O)₅₀—(CH₂CH₂O)₈—H, wherein the polyoxyethylene:polyoxypropylene chain length ratio is outside the range from 4:1 to 7:1 (comparative composition 2):

| | % [by |
|---|---|
| Comparative composition 2 | weight] |
| Thiamethoxam | 47.6% |
| Polyoxypropylene-polyoxypropylene block copolymer | 2.1% |
| HO—(CH₂CH₂O)₈—(CH(CH₃)CH₂O)₅₀—(CH₂CH₂O)₈—H | |
| Ethoxylated lignosulfonate sodium salt | 3.4% |
| (degree of sulfonation: 1.2 moles/Kg) | |
| Smectite clay | 1% |
| Xanthan gum | 0.11% |
| Dispersant | 1.4% |
| Liquid carrier | 6% |
| Solid carrier | 1% |
| Preservative | 0.2% |
| Antifoam | 0.1% |
| Water | up to |
| | 100% |

Non-limiting examples of block copolymers of ethylene oxide and propylene oxide suitable for use in the pesticidal composition of Comparative Example 2 include, for instance, surfactants which are commercially available under the trademark name PLURONIC® L92.

### Comparative Example 3

An aqueous flowable concentrate for seed treatment containing the compound of formula (I) as active ingredient was prepared according to the procedure as set forth in Example 1 but replacing the block copolymer of ethylene oxide and propylene oxide of formula (II) with HO—(CH₂CH₂O)₁₉—(CH(CH₃)CH₂O)₃₉—(CH₂CH₂O)₁₉—H, wherein the polyoxyethylene:polyoxypropylene chain length ratio is outside the range from 4:1 to 7:1 (comparative composition 3):

| | % [by |
|---|---|
| Comparative composition 3 | weight] |
| Thiamethoxam | 47.6% |
| Polyoxypropylene-polyoxypropylene block copolymer | 2.1% |
| HO—(CH₂CH₂O)₁₉—(CH(CH₃)CH₂O)₃₉—(CH₂CH₂O)₁₉—H | |
| Ethoxylated lignosulfonate sodium salt | 3.4% |
| (degree of sulfonation: 1.2 moles/Kg) | |
| Smectite clay | 1% |
| Xanthan gum | 0.11% |
| Dispersant | 1.4% |
| Liquid carrier | 6% |
| Solid carrier | 1% |
| Preservative | 0.2% |
| Antifoam | 0.1% |
| Water | up to |
| | 100% |

Non-limiting examples of block copolymers of ethylene oxide and propylene oxide suitable for use in the pesticidal composition of Comparative Example 3 include, for instance, surfactants which are commercially available under the trademark name PLURONIC® P84.

### Comparative Example 4

An aqueous flowable concentrate for seed treatment containing the compound of formula (I) as active ingredient was prepared according to the procedure as set forth in Example 1 but without an ethoxylated lignosulfonate sodium salt (comparative composition 4).

Tests have been carried out by pouring samples of the compositions of any one of Example 1, Example 2 and Comparative Examples 1 to 4 into a cup and checking for any sediments remaining in the bottom of the cup through visual assessment. The results are as set forth in Table 1 below.

### Comparative Example 5

An aqueous flowable concentrate for seed treatment containing the compound of formula (I) as active ingredient was prepared according to the procedure as set forth in Example 1 but replacing the block copolymer of ethylene oxide and propylene oxide of formula (II) with HO—(CH₂CH₂O)₁₂₇—(CH(CH₃)CH₂O)₄₈—(CH₂CH₂O)₁₂₇—H, wherein the polyoxyethylene:polyoxypropylene chain length ratio is in the range from 4:1 to 7:1, but x and x′ are integers outside the range from 70 to 120, and y is an integer outside the range from 20 to 45 (comparative composition 5):

| | % [by |
|---|---|
| Comparative composition 5 | weight] |
| Thiamethoxam | 47.6% |
| Polyoxypropylene-polyoxypropylene block copolymer | 2.1% |
| HO—(CH₂CH₂O)₁₂₇—(CH(CH₃)CH₂O)₄₈—(CH₂CH₂O)₁₂₇—H | |
| Ethoxylated lignosulfonate sodium salt | 3.4% |
| (degree of sulfonation: 1.2 moles/Kg) | |
| Smectite clay | 1% |
| Xanthan gum | 0.11% |
| Dispersant | 1.4% |
| Liquid carrier | 6% |
| Solid carrier | 1% |
| Preservative | 0.2% |
| Antifoam | 0.1% |
| Water | up to |
| | 100% |

Non-limiting examples of block copolymers of ethylene oxide and propylene oxide suitable for use in the pesticidal composition of Comparative Example 5 include, for instance, surfactants which are commercially available under the trademark name PLURONIC® F108.

As shown in Table 1, the sedimentation index is an integer comprised between 1 and 5 that takes into account the long term physical stability upon storage of the formulation. When the formulation is fully homogeneous on storage, the index is 5. When the index is 3 or higher, the formulation advantageously shows a satisfactory stability performance as it can be easily rehomogenised by pouring the sample back and forth no more than 5-10 times. When the index is 1 or 2, the formulation disadvantageously shows a high sedimentation rate and settles to the bottom of the cup.

The pesticidal compositions of the invention including, for instance, the composition 1 of Example 1 and the composition 2 of Example 2 show an improved sedimentation profile in comparison to the comparative compositions 1, 2 and 3 comprising a block copolymer of ethylene oxide and propylene oxide of formula (II), wherein the polyoxyethylene:polyoxypropylene chain length ratio is outside the range from 4:1 to 7:1 (see Comparative Examples 1-3).

The pesticidal compositions of the invention including, for instance, the composition 1 of Example 1 further show an easier rehomogenisation of the sediments in the presence of an additional clay together with an additional heteropolysaccharide in comparison to the composition 2 of Example 2 which is free from the clay.

The pesticidal compositions of the invention including, for instance, the composition 1 of Example 1 and the composition 2 of Example 2 also show good crystal inhibition properties in comparison to the comparative composition 4 of Comparative Example 4, which is free from an ethoxylated lignosulfonate sodium salt. While the comparative composition 4 shows a satisfactory stability performance, crystal growth takes place in storage in comparison to the composition 1 and the composition 2 thereby undesirably generating cloudiness.

TABLE 1

Stability performance

| | 2 weeks | 2 weeks | 4 weeks | 8 weeks |
|---|---|---|---|---|
| | (54° C.) | (50° C.) | (50° C.) | (50° C.) |
| Example 1 | 3 | 4 | 4 | 3 |
| Example 2 | 3 | 4 | 3 | 3 |
| C. Example 1 | 1 | 1 | 1 | 1 |
| C. Example 2 | 1 | 1 | 1 | 1 |
| C. Example 3 | 1 | 2 | 2 | 2 |
| C. Example 4 | 3 | 3 | 3 | 3 |
| C. Example 5 | — | 1 | 2 | — |

1. A pesticidal composition comprising:
(a) a compound of formula (I): 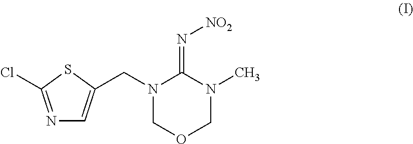 [SMILES: CN1COCN(Cc2cnc(Cl)s2)/C1=N/[N+](=O)[O-]]
or an agrochemically acceptable salt, stereoisomer, enantiomer, tautomer or N-oxide thereof;
(b) water; and
(c) a surfactant system comprising:
at least one block copolymer of ethylene oxide and propylene oxide of formula (II):
HO—(CH₂CH₂O)ₓ—(CH(CH₃)CH₂O)_{y}—(CH₂CH₂O)ₓ—H (II)
wherein
x and x′, equal to or different from each other, are integers from 70 to 120, and
y is an integer from 20 to 45, and
wherein the polyoxyethylene:polyoxypropylene chain length ratio is from 4:1 to 7:1, and
at least one alkoxylated lignosulfonate salt of formula (III): 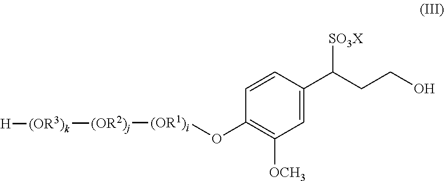
R¹, R² and R³, equal to or different from each other, are independently selected from —CH₂CH₂—, —CH(CH₃)CH₂— and —CH₂CH₂CH₂CH₂—,
i, j and k, equal to or different from each other, are 0 or integers from 1 to 15, with the proviso that at least one of i, j and k is different from 0, and
X is sodium or potassium.

2. The composition according to claim 1, wherein in the block copolymer of ethylene oxide and propylene oxide of formula (II)
x and x′, equal to or different from each other, are integers from 75 to 85, and
y is an integer from 25 to 35, and
wherein the polyoxyethylene:polyoxypropylene chain length ratio is from 5:1 to 6:1.

3. The composition according to claim 1, wherein in the block copolymer of ethylene oxide and propylene oxide of formula (II)
x and x′, equal to or different from each other, are integers from 75 to 80, and
y is an integer from 25 to 30, and
wherein the polyoxyethylene:polyoxypropylene chain length ratio is from 5:1 to 6:1.

4. The composition according to claim 1, wherein
the polyoxyethylene:polyoxypropylene chain length ratio is between 5.1:1 and 5.5:1.

5. The composition according to claim 1, wherein
in the alkoxylated lignosulfonate salt of formula (III)
when any of R¹, R² and R³ is —CH₂CH₂, i, j and k, equal to or different from each other, are integers from 1 to 12, preferably from 1 to 4, more preferably from 1 to 3, or
when any of R¹, R² and R³ is —CH(CH₃)CH₂, i, j and k, equal to or different from each other, are integers from 1 to 6, preferably from 1 to 3, more preferably from 1 to 2, or
when any of R¹, R² and R³ is —CH₂CH₂CH₂CH₂—, i, j and k, equal to or different from each other, are integers from 1 to 3, preferably from 1 to 2, more preferably 1,
wherein R¹, R² and R³ are equal to or different from each other.

6. The composition according to claim 1, wherein
the surfactant system comprises:
from 35% to 40% by weight, with respect to the total weight of the surfactant system, of at least one polyoxyethylene-polyoxypropylene block copolymer of formula (II); and
from 60% to 65% by weight, with respect to the total weight of the surfactant system, of at least one alkoxylated lignosulfonate salt of formula (III).

7. The composition according to claim 1, said composition further comprising:
(d) at least one clay; and
(e) at least one heteropolysaccharide.

8. The composition according to claim 7, wherein the weight ratio of at least one clay to at least one heteropolysaccharide is from 8:1 to 15:1.

9. The composition according to claim 7, wherein the weight ratio of at least one clay to at least one heteropolysaccharide is from 9:1 to 10:1.

10. The composition according to claim 1, said composition comprising:
(a) from 10% to 75% by weight, with respect to the total weight of the composition, of the compound of formula (I) or an agrochemically acceptable salt, stereoisomer, enantiomer, tautomer or N-oxide thereof;
(b) from 10% to 65% by weight, with respect to the total weight of the composition, of water;
(c) from 1% to 25% by weight, with respect to the total weight of the composition, of the surfactant system;
(d) from 0.1% to 2% by weight, with respect to the total weight of the composition, of at least one clay; and
(e) from 0.05% to 1% by weight, with respect to the total weight of the composition, of at least one heteropolysaccharide.

11. The composition according to claim 1, said composition comprising:
(a) from 25% to 60% by weight, with respect to the total weight of the composition, of the compound of formula (I) or an agrochemically acceptable salt, stereoisomer, enantiomer, tautomer or N-oxide thereof;
(b) from 25% to 60% by weight, with respect to the total weight of the composition, of water;
(c) from 2% to 15% by weight, with respect to the total weight of the composition, of the surfactant system;
(d) from 0.5% to 1.5% by weight, with respect to the total weight of the composition, of at least one clay; and
(e) from 0.05% to 0.15% by weight, with respect to the total weight of the composition, of at least one heteropolysaccharide.

12. The composition according to claim 1, said composition comprising:
(a) from 40% to 60% by weight, with respect to the total weight of the composition, of the compound of formula (I) or an agrochemically acceptable salt, stereoisomer, enantiomer, tautomer or N-oxide thereof;
(b) from 30% to 50% by weight, with respect to the total weight of the composition, of water;
(c) from 4% to 10% by weight, with respect to the total weight of the composition, of the surfactant system;
(d) from 0.08% to 1.2% by weight, with respect to the total weight of the composition, of at least one clay; and
(e) from 0.06% to 0.15% by weight, with respect to the total weight of the composition, of at least one heteropolysaccharide.

13. A method of controlling insects, acarines, nematodes or molluscs which comprises applying an insecticidally, acaricidally, nematicidally or molluscicidally effective amount of the pesticidal composition according to claim 1 to a pest, a locus of pest, to a plant susceptible to attack by a pest or to plant a propagation material thereof.

14. The method according to claim 13, wherein the plant is selected from the group consisting of cereals, vegetables, field crops, oil seed crops, forage crops and fiber crops.

15. Use of the pesticidal composition according to claim 1 as an insecticide, acaracide, nematicide or molluscicide.
